(19) United States
(12) Patent Application Publication
(10) Pub. No.: US 2014/0072938 A1
(43) Pub. Date: Mar. 13, 2014

(54) METHOD AND SYSTEM FOR TRAINING SPORTS OFFICIALS

(71) Applicant: Curtis J. Krull, Orange City, IA (US)

(72) Inventor: Curtis J. Krull, Orange City, IA (US)

(21) Appl. No.: 14/026,555

(22) Filed: Sep. 13, 2013

Related U.S. Application Data
(60) Provisional application No. 61/700,563, filed on Sep. 13, 2012.

(51) Int. Cl. G09B 5/02

(52) U.S. Cl. CPC G09B 5/02
USPC 434/219

(57) ABSTRACT

A method and system is provided for training sports referees, and particularly to help referees understand the application of rules to game plays or situations between competitors. The method and system includes live action plays recorded from one or more referee perspectives on the field or court. The plays are downloaded into a database so that a trainee can select specific plays and apply specific rules to the selected plays so as to understand application of the rule to a game situation. Multiple perspectives of the same play can be recorded and viewed simultaneously in real time or frame by frame.

### CROSS-REFERENCE TO RELATED APPLICATIONS

This application claims priority under 35 U.S.C. §119 to provisional application Serial No. 61/700,563 filed Sep. 13, 2012, herein incorporated by reference in its entirety.

### FIELD OF THE INVENTION

The present invention relates to a method and system for training sports referees, including sports such as basketball, football, baseball, hockey, soccer, volleyball, wrestling, and nearly any other sport which utilizes referees, umpires, or other officiators (hereinafter collectively and generically referred to as “referees”), who need to understand the rules of the sport and violations of those rules.

### BACKGROUND OF THE INVENTION

Referees for sporting events at all levels of competition, from youth sports to professional, are often trained using game film or videos which they review to help understand how the rules of their sport apply to specific plays or situations. The plays are typically filmed or videotaped from an elevation high above the field or court, such as a press box, a lift platform, or other elevated and distant position. While such videos usually show the entire field or court of play, these elevated videos from a distance are not the same as what a referee sees on the field or on the court during live action. These prior art videos provide a wide angle perspective, whereas the referee has a much narrower and close-up perspective or view of the action.

Therefore, there is a need for improved training methods and systems which will enhance the teaching and training process of the referees.

Accordingly, a primary objective of the present invention is the provision of a method and system of training referees using plays recorded from the referee's normal positions on the field, court or venue of play.

Another objective of the present invention is the provision of a method and system for training referees and other sporting officials using a computer and software program which includes numerous plays recorded from the referee's vantage point on the playing surface, so as to learn and understand application of the sport's rules to the plays.

Still another objective of the present invention is the provision of a method and system for training referees wherein the trainee selects one or more videos of plays made from a referee's eye-level on the field or court.

Yet another objective of the present invention is the provision of a method and system for training referees wherein plays recorded from the referee's viewpoint on the field or court are downloaded into a database, with the downloaded plays being available for selected viewing during the training process.

Another objective of the present invention is the provision of a method and system for training referees who selectively view one or more plays showing game situations recorded on the field or court from a referee's eye-level.

A further objective of the present invention is a method and system for training referees which enhance and expedites a trainee's understanding and application of the rules of their sport.

These and other objectives will become apparent from the following description of the invention.

### SUMMARY OF THE INVENTION

An improved method and system is provided for training referees for sporting events and activities of all kinds Training includes introduction, demonstration, and testing. The system includes a plurality of plays recorded from games or matches, from one or more referee eye-level positions on the field, court, or surface of play. The recorded plays are downloaded into a database. A trainee selects downloaded plays to view on a monitor or screen along with statements of the rules. Plays can be viewed at full speed or slow motion and can be stopped at any point to focus on the play action to see how specific rules apply to the action. Multiple perspectives of each play from different positions on the field or court can be viewed simultaneously. Software allows the trainee to be tested and/or evaluated for their understanding of the rules.

### BRIEF DESCRIPTION OF THE DRAWINGS

FIG. 1 shows an example of a screen shot of a computer monitor using the software of the present invention wherein multiple views of the same basketball play from different referee perspectives are provided.

FIGS. 2 and 3 show alternative screen layouts with multiple views of a play from different perspectives on the court or field.

FIG. 4 shows a test screen for a trainee.

### DETAILED DESCRIPTION OF THE PREFERRED EMBODIMENTS

The method and system of the present invention is intended for use in training sports officials, such as referees, umpires, and the like, using films or videotapes of game situations so that the rules of the games can be applied to such situations. The videos are taken from the referee's eye-level and perspective and positions on the field or court using miniature cameras mounted or carried on the official's body during play action. The method and system can be used for various sports, including basketball, football, baseball, hockey, soccer, volleyball, wrestling, and any other sport which utilizes referees, umpires, or other game match or meet officials for enforcement of the game rules. Using this system and method of the present invention will enhance and expedite training of referees.

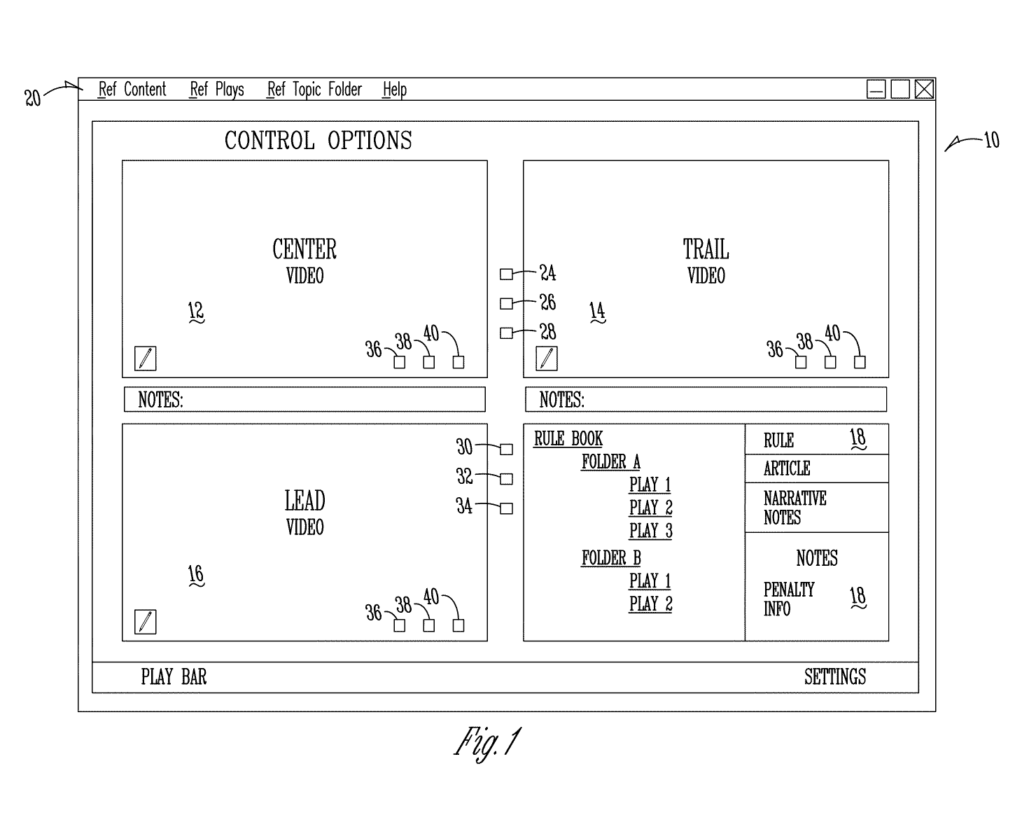

For example, basketball typically includes three referees, generally designated as the lead, center and trail referees, which corresponds to their position on the court during play. A miniature, lightweight camera can be strapped or attached on the head of each of these referees to videotape live game action from each referee's perspective or position on the court as the plays develop. The videotaped plays are then downloaded into a database on a computer or laptop, tablet, or other processor or device using a software program for later viewing by a trainee referee. Alternatively, the plays can be accessed through a link to an Internet site where the plays are stored. The trainee referee or trainer can select from the available plays. Each selected play will be presented on a monitor or screen from the lead, center and trail referee cameras, as shown in FIG. 1. The trainee referee or trainer can pause and play the game action in normal speed or slow motion, as desired, so as to view the play from different perspectives. The trainee or trainer can also enlarge any of the perspectives to a full screen. The partial screen and full screen plays can be paused, and then forwarded or reversed frame by frame for review and/or discussion of difficult rules or situations. The trainee referee or trainer can analyze the selected play and compare it to the game rules to see whether a violation of the rules has occurred. Different play situations can be sequentially viewed by the trainee referee as applied to the same or different rules, thereby developing the trainee referee's understanding of the rules and how the rules apply to different game situations.

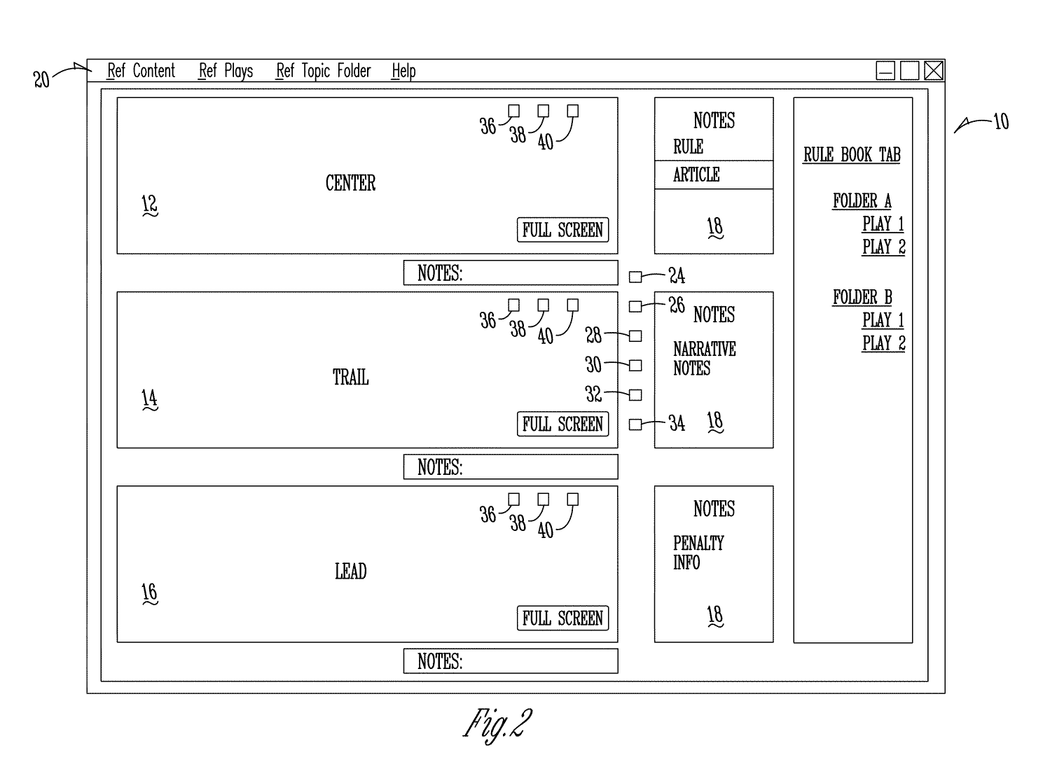

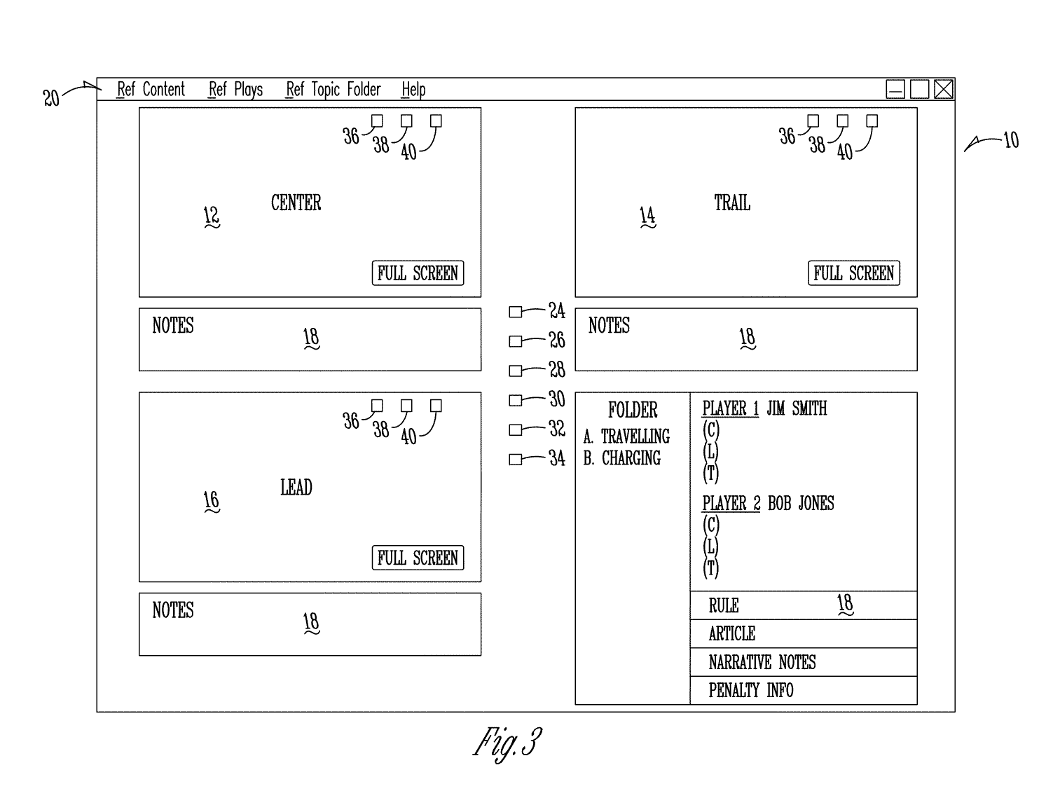

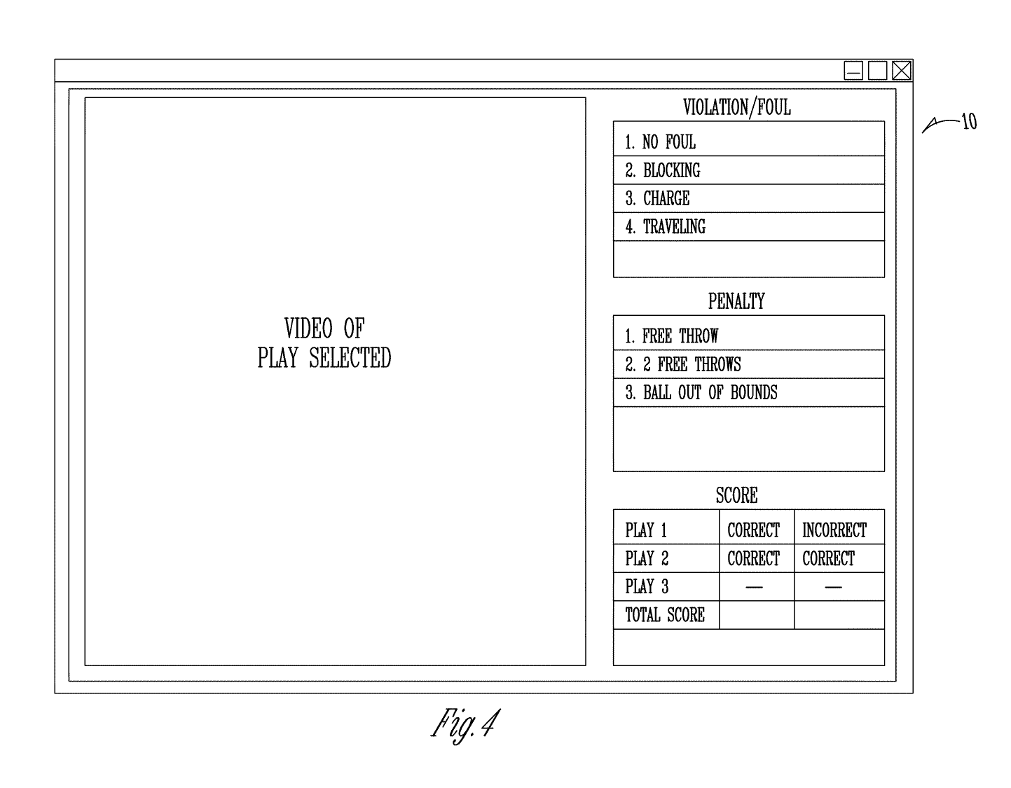

The viewing monitor or screen may also include areas for a trainee referee to add notes or comments, such as in the lower right quadrant of FIGS. 1 and 3, or the right portion of FIG. 2.

This referee training tool is built upon two open source LGPL licensed third party libraries: The Qt Tool Kit (http://qt.nokia.com) and Toadlet Engine (http://code.google.com/p/toadlet). A video library of plays is built on top of these tool kits, with the library containing all of the functionality for the applications, including video conversion and playback, image loading, playbook management, user interface elements, and more.

For example, the various sports to which the method and system of the present invention apply will generally include the following key, common features:
Video files may be loaded from a wide variety of different formats and sizes;
All videos are converted into a common format when loaded;
Multiple videos of a particular play from different positions may be synchronized and played together;
Individual videos and diagrams may be displayed in full screen mode;
Videos may be displayed and played on flat or curved surfaces;
View navigation can be provided to observe curved video from different orientations;
Still images may be loaded and displayed;
Drawing may be performed on a layer on top of the videos or still images;
Any combination of vides and/or images may be added;
Textual notes may be added and stored;
Plays may be organized into a series of folders;
An exam mode may be run which tests the trainee's or user's knowledge of plays, formulations, rules and more.

Thus, once the plays are videotaped and downloaded onto a computer for storage in a database using the software, or otherwise stored for accessibility of use, various teaching and test modes can be utilized for the training of referees. The method and system of the present invention teaches the plays and measures comprehension of the rules, while allowing the user to manage the play books or folders.

The videos, taken from the referee's perspective or position on the playing venue allows the training sessions to be conducted without being on the court or field or otherwise being present at live play action. The playbook database can be organized in any desired manner, such as different files corresponding to different rules. Trainers and/or trainees can add digital or electronic notes to specific plays or folders. Use of this method and system trains a referee to recognize rule violations more quickly and accurately.

Examples of the present invention are shown in the following YouTube presentations, which show application of the invention for basketball referees, and which are incorporated herein by reference.
The Referee “Introduction Video”—http://www.youtube.com/watch?v=fKSJ4ISanBI
Referee Plays video—http://www.youtube.com/watch?NR=1&v=GWVG4I5e-uc&feature=endscreen
The Referee Folders http://www.youtube.com/watch?NR=1&v=M-Y3KMxhi9w&feature=endscreen
Using Referee Rulebook http://www.youtube.com/watch?NR=1&v=2AA8V-SXKzE&feature=endscreen
Playing Referee Video http://www.youtube.com/watch?feature=endscreen&v=MBIzOGFpLKk&NR=1

This new method and system is an effective way to teach sports officials the rules of the game and how to interpret the rules, while watching live game action. Preferably, the video is shot using high definition digital technology, from the referee's own eye-level, rather than from a remote distance in the stands, to show visual interpretation of various play situations and violations. The multiple screen system allows the user to select a play and view all three perspectives simultaneously, or to enlarge one of the perspectives. The views, whether watched at the same time or separately, can be paused, and moved forward or backwards frame by frame to study the play.

The system combines the HD videos of each play or situation with the written rules. Every video clip is a visual representation of a specific rule or violation, with the rule being selectively displayed on the monitor or screen alongside the video(s). A short narrative and penalty explanation may also be provided simultaneously with the video plays. Thus, the trainee referee has both the visual play and the written rule available together or separately (such as sequentially) in the learning environment. The user can also make their own notes on any specific play using the text box on the monitor or screen adjacent the video portion of the screen.

### Software

Once the software is downloaded, the interface can be opened using an icon installed on the desktop, laptop, tablet or other device. As shown in FIG. 1, the monitor or screen 10 will be divided into quadrants, with three video areas 12, 14, 16 and one or more text or note areas 18. Initially, the video screens will be blank. One or more folders can be created and managed from the menus in the title bar 20 at the top of the screen and the playback controls 24, 26, 28, 30, 32, 34 on the screen 10. New or additional video plays can be added to a folder from the play library. Alternative layouts for the screen are shown in FIGS. 2 and 3.

When the software is opened by a user, multiple tabs will be available for the user's selection, including a play library, topic folder, and a rule book tab. Using the topic folder tab, a user can create and manage folders that contain varies plays selected from the plays tab. All folders will be listed, and new folders can be added. Each folder can be named or renamed. Plays can be selectively added to an open folder from the plays tab. Plays can be saved or deleted from folders. Folders can also be deleted or loaded to the rule book under the rule book tab. Any play can be included in multiple folders.

The plays tab contains all of the plays that have been downloaded and are available to assign to one or more folders or to the rule book. Plays can be named, renamed, or deleted from the play list.

The rule book tab interfaces with the folder and plays tabs, allowing plays to be moved to and from the folders into and from the rule book, and allowing folders to be moved to and from the rule book. The rule book allows the user to insert the proper rule or article that applies to each specific video. When a play is selected to be viewed by a user, the name of the play and the rule number automatically appears on the monitor or screen. The user can also add the appropriate penalty for a rule violation under the rule book tab. All edited editions and deletions from the rule book are saved.

Once a folder is created, plays are loaded into the folder and the folder is loaded to the rule book, the user can select the desired play, and the multiple views of the action from different referee perspectives will appear in the multiple panels 12, 14, 16, on the monitor or screen, as shown in FIGS. 1, 2 and 3. Control buttons allow the user to control viewing of the selected play. For example, the top button 24 is a start button so that all three screens will begin the play at the same time. The next button 26 is a reset button that returns to the beginning of the video as the play is running The third button 28 from the top is a pause button which stops the play on all three screens at the same time. With the play paused, the forth button 30 allows the play to be rewound and reversed frame by frame, while the fifth button 32 allows the play to be advanced or forwarded frame by frame. The bottom button 34 restarts the play at the beginning after the play has been paused. The user can also start or pause with a right click of the mouse.

Each screen also has three icons in one corner. The left icon 36 allows the user to draw on the screen, for example, to make points of emphasis. The middle icon 38 erases any drawn lines. The right icon 40 will enlarge the selected screen to a full screen size on the monitor. These control icons will remain on the full screen, as well as on the split screen. A pencil icon can also be provided for writing or drawing, as shown in the figures.

Thus, the software allows multiple videos to be synchronized in a single application window, providing standard video control to the user, and allowing the user to create play notes about the videos. The videos from the video library can be selectively downloaded into folders so that the videos can be later viewed by a trainee and/or trainer with start, stop, and frame by frame forward and reverse reviewing of the play action.

For testing a trainee, the user would create a new folder and load the plays to be tested. The folder would be loaded into the Rulebook and the interface would have a “Test” selection next to the “Open”, “Add” and “Remove” selections. Once the “Test” selection is clicked, the plays would appear in a column with the words “Play 1”, “Play 2”, etc. The person being tested would select one of the plays and it would appear in one half of the screen (it can be the upper half, lower half or to one side). The specific view of the play would be predetermined, i.e., for basketball, from the center, lead or trail perspective. The other half of the screen would have multiple choice options at the upper quarter, the penalty for the foul in the next quarter panel, the next step, i.e., taking the ball out, and the final quarter would have the cumulative score for the test.

The test process can be done by manual multiple choice selection or, with the right software, by voice recognition, so that the test subject simply has to say the violation and the penalty. Also, a time element can be used in the test so that if the test subject doesn't recognize a foul or violation within a second or so, the test will register a “No call”.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of training sports referees, comprising:
recording sporting plays at a sports venue from a first perspective of a person on a playing surface where the sport is being played;
downloading the recorded plays into a database;
selecting at least one play from the database for viewing on a monitor;
viewing the selected play by a trainee; and
applying a rule of sport to the viewed play.

2. The method of claim 1 wherein the recording is made with a camera on a first referee positioned on the playing surface.

3. The method of claim 2 further comprising recording the plays from a second perspective of a second referee on the playing surface.

4. The method of claim 3 wherein the first and second perspective plays can be simultaneously viewed on the monitor by the trainee.

5. The method of claim 1 wherein training is provided for referees selected from a group of sports comprising football, basketball, baseball, soccer, hockey, volleyball, and wrestling.

6. The method of claim 1 further comprising providing videos of each play from multiple perspectives at approximately the eye-level of persons on the playing surface.

7. The method of claim 6 further comprising viewing the multiple perspectives of each play simultaneously on the monitor.

8. The method of claim 1 further comprising pausing the selected play.

9. The method of claim 8 further comprising reviewing the selected play frame by frame.

10. The method of claim 1 further comprising measuring the trainee referee's understanding of rules of their sport based on the selected plays.

11. A system for training referees, comprising:
a database of game plays recorded by at least one person on a playing field or court during play action;
a screen to view selected plays from the database;
controls for selecting and viewing the recorded plays;
the database including rules corresponding to each play so that a trainee can watch the selected plays and learn the corresponding rules.

12. The system of claim 11 wherein the plays are recorded at substantially the eye-level of the person on the court or field.

13. The system of claim 11 wherein the person is a referee.

14. The system of claim 13 wherein the referee wears a camera to record the plays.

15. The system of claim 11 wherein each play is recorded from multiple perspectives by different people on the field or court.

16. The system of claim 15 wherein the multiple perspectives of the selected play are viewed simultaneously on the monitor.

17. The system of claim 11 wherein the plays are viewable in real time and frame by frame.

18. The system of claim 11 further comprising a test mode to evaluate the trainee's understanding of the rules.

19. A method of training referees, comprising:
recording live action competition by each referee on a competition surface from multiple referee positions on the surface;
to create a set of recordings showing the action from multiple perspectives on the playing surface downloading the set of recordings simultaneously;
comparing the action on the recordings to a specific rule of sport.

20. The method of claim 19 further comprising repeating the recording and downloading steps for different live actions from the competition to create multiple sets of recordings of the different actions; and then selecting one of the sets for the viewing and comparing steps.
